(19) United States
(12) Patent Application Publication
(10) Pub. No.: US 2026/0221563 A1
(43) Pub. Date: Jul. 30, 2026

(54) GASKET FOR ELECTROCHEMICAL DEVICE, AND ELECTROCHEMICAL DEVICE

(71) Applicant: DAIKIN INDUSTRIES, LTD., Osaka (JP)

(72) Inventors: Masahiko YAMADA, Osaka (JP); Tomihiko YANAGIGUCHI, Osaka (JP); Taketo KATO, Osaka (JP); Takeru USHIJIMA, Osaka (JP)

(73) Assignee: DAIKIN INDUSTRIES, LTD., Osaka (JP)

(21) Appl. No.: 19/574,963

(22) Filed: Mar. 23, 2026

Related U.S. Application Data
(63) Continuation of application No. PCT/JP2024/034984, filed on Sep. 30, 2024.

(30) Foreign Application Priority Data
Sep. 29, 2023 (JP) 2023-169987

(51) Int. Cl. H01M 50/193

(52) U.S. Cl. CPC H01M 50/193

(57) ABSTRACT

A gasket for an electrochemical device with excellent water vapor barrier properties, and an electrochemical device including the gasket. A gasket for an electrochemical device containing polybutylene terephthalate, the gasket having a compression ratio upon installation of 5% or more.

### CROSS-REFERENCE TO RELATED APPLICATIONS

This application is a Rule 53(b) Continuation of International Application No. PCT/JP2024/034984 filed Sep. 30, 2024, which claims priority based on Japanese Patent Application No. 2023-169987 filed Sep. 29, 2023, the respective disclosures of which are incorporated herein by reference in their entirety.

### TECHNICAL FIELD

The disclosure relates to a gasket for an electrochemical device and an electrochemical device.

### BACKGROUND ART

It is known that resins such as perfluoroalkoxy alkane (PFA) are used as sealing members (gaskets) for electrochemical devices such as lithium ion secondary batteries (see Patent Literatures 1 to 4, for example).

### CITATION LIST

### Patent Literature

Patent Literature 1: JP 2017-174732 A
Patent Literature 2: WO 2020/066050
Patent Literature 3: WO 2014/049645
Patent Literature 4: JP 2021-141045 A

### SUMMARY

The disclosure (1) relates to a gasket for an electrochemical device containing polybutylene terephthalate, the gasket having a compression ratio upon installation of 5% or more.

### Advantageous Effects

The disclosure can provide a gasket for an electrochemical device with excellent water vapor barrier properties and an electrochemical device including the gasket.

### BRIEF DESCRIPTION OF THE DRAWINGS

FIG. 1 is a schematic cross-sectional view showing the configuration of a portion of an electrochemical device including a gasket.

FIG. 2 is a schematic cross-sectional view of a transmission test jig used in a water vapor transmission test.

### DESCRIPTION OF EMBODIMENTS

It has been discovered that, even when a gasket is formed from a material traditionally regarded as having poor water vapor barrier properties, the water vapor transmission can be reduced by setting the compression ratio of the gasket to fall within a specific range upon installation in an electrochemical device.

The disclosure is described in detail below.

The disclosure provides a gasket for an electrochemical device containing polybutylene terephthalate (PBT) and having a compression ratio upon installation of 5% or more (hereafter, also referred to as gasket (1) of the disclosure).

The gasket (1) of the disclosure having the above structure has excellent water vapor barrier properties.

The gasket (1) of the disclosure and the later-described gasket (2) of the disclosure are herein collectively referred to as “gasket of the disclosure”, unless otherwise stated.

The gasket (1) of the disclosure has a compression ratio of 5% or more upon installation. In order to further improve the water vapor barrier properties, the compression ratio upon installation is preferably 10% or more, more preferably 15% or more, still more preferably 20% or more, further preferably 25% or more, further preferably 30% or more, particularly preferably 40% or more, while it is preferably less than 75%, more preferably 70% or less, still more preferably 65% or less, further preferably less than 65%.

The compression ratio can be calculated using the following formula.

$$Compression ratio ( \% ) = [ ( Thickness of gasket before compression ) - ( Thickness of gasket after compression ) ] / ( Thickness of gasket before compression ) \times 100$$

In the case where the compression ratio is obtained using an installed gasket, a cross section of the gasket installed and compressed is observed using an X-ray photograph. The thickness of the gasket at the point where the distance between the opposing faces is shortest in the compressed portion upon installation may be taken as the thickness of the gasket after compression, and the thickness of the gasket at the point where the thickness is greatest in the uncompressed portion may be taken as the thickness of the gasket before compression.

Alternatively, the gasket is removed from the installed state and subjected to the heat treatment at 150° C. for 24 hours, and the thickness of the resulting gasket may be taken as the thickness of the gasket before compression.

The gasket (1) of the disclosure preferably has a compression ratio less than the compression ratio at break, that is, the gasket (1) preferably does not break under compression at the compression ratio upon installation.

The compression ratio at break is determined as the compression ratio at the time when the gasket breaks in a compression test in accordance with JIS K 7181:2011 using a ring-shaped gasket with a rectangular cross section, an outer diameter of 17.7±0.1 mm, an inner diameter of 14.2±0.1 mm, and a thickness of 1.6±0.05 mm (L₀).

In order to further improve the water vapor barrier properties, the gasket (1) of the disclosure preferably has a water vapor transmission coefficient of 0.015 g/1000 hr or less, more preferably less than 0.010 g/1000 hr, still more preferably 0.009 g/1000 hr or less, further preferably 0.008 g/1000 hr or less, further preferably 0.007 g/1000 hr or less, further preferably 0.006 g/1000 hr or less, particularly preferably 0.005 g/1000 hr or less, while it may have a water vapor transmission coefficient of 0.0001 g/1000 hr or more. The water vapor transmission coefficient is determined by measuring the mass of water passing through a ring-shaped gasket with a rectangular cross section, an outer diameter of 17.7 mm, an inner diameter of 14.3 mm, and a thickness of 1.6 mm, at the above-described compression ratio upon installation under the conditions of 80° C. for 1000 hours.

The gasket (1) of the disclosure may contain a component other than PBT but preferably consists essentially of PBT. This allows remarkable exertion of the effect attributable to PBT. The phrase “consists essentially of PBT” means that the amount of PBT is 95.0% by mass or more based on the gasket.

The amount of PBT is preferably 98.0% by mass or more, more preferably 99.0% by mass or more, still more preferably 99.5% by mass or more, particularly preferably 99.9% by mass or more, most preferably 99.95% by mass or more based on the gasket.

The gasket (1) of the disclosure also preferably consists of PBT.

The disclosure also provides a gasket for an electrochemical device containing a polymer and having a compression ratio upon installation of 20% or more and 75% or less (hereafter, also referred to as gasket (2) of the disclosure).

The gasket (2) of the disclosure having a compression ratio upon installation of 20% or more and 75% or less has excellent water vapor barrier properties. In order to further improve the water vapor barrier properties, the compression ratio is preferably 25% or more, more preferably 30% or more, still more preferably 40% or more, while it is preferably less than 75%, more preferably 70% or less, still more preferably 65% or less, further preferably less than 65%.

The compression ratio can be calculated using the following formula.

$$Compression ratio ( \% ) = [ ( Thickness of gasket before compression ) - ( Thickness of gasket after compression ) ] / ( Thickness of gasket before compression ) \times 100$$

In the case where the compression ratio is obtained using an installed gasket, a cross section of the gasket installed and compressed is observed using an X-ray photograph, and the thickness of the gasket at the point where the distance between the faces is the shortest in the portion compressed by installation may be taken as the thickness of the gasket after compression and the thickness of the gasket at the point where the thickness is greatest in the uncompressed portion may be taken as the thickness of the gasket before compression.

Alternatively, the gasket is removed from the installed state and subjected to the heat treatment at 150° C. for 24 hours, and the thickness of the resulting gasket may be taken as the thickness of the gasket before compression.

The gasket (2) of the disclosure preferably has a compression ratio less than the compression ratio at break, that is, the gasket (2) preferably does not break under compression at the compression ratio upon installation.

The compression ratio at break is determined as the compression ratio at the time when the gasket breaks in a compression test in accordance with JIS K 7181:2011 using a ring-shaped gasket with a rectangular cross section, an outer diameter of 17.7±0.1 mm, an inner diameter of 14.2±0.1 mm, and a thickness of 1.6±0.05 mm (L₀).

In order to further improve the water vapor barrier properties, the gasket (2) of the disclosure preferably has a water vapor transmission coefficient of less than 0.010 g/1000 hr, more preferably 0.009 g/1000 hr or less, still more preferably 0.008 g/1000 hr or less, further preferably 0.007 g/1000 hr or less, further preferably 0.006 g/1000 hr or less, particularly preferably 0.005 g/1000 hr or less, while it may have a water vapor transmission coefficient of 0.0001 g/1000 hr or more.

The water vapor transmission coefficient is determined by measuring the mass of water passing through a ring-shaped gasket with a rectangular cross section, an outer diameter of 17.7 mm, an inner diameter of 14.3 mm, and a thickness of 1.6 mm, at the above-described compression ratio upon installation under the conditions of 80° C. for 1000 hours.

The gasket (2) of the disclosure contains a polymer, preferably a polymer having a degree of fluorine substitution of 95% or less. Polymers having a low degree of fluorine substitution have advantages such as low processing costs, ease of processing, and low specific gravity, but may have poor barrier properties against water vapor or the like. The gasket of the disclosure has excellent water vapor barrier properties even when it contains a polymer having a low degree of fluorine substitution.

The degree of fluorine substitution of the polymer can be calculated using the following formula.

$$Degree of flourine substitution ( \% ) = ( Number of flourine atoms bonded to carbon atoms in polymer ) / ( ( Number of hydrogen atoms bonded to carbon atoms in polymer ) + ( Number of flourine atoms and chlorine atoms bonded to carbon atoms in polymer ) \times 100$$

Examples of the polymer having a degree of fluorine substitution of 95% or less include a fluoropolymer having a degree of fluorine substitution of 95% or less and a non-fluoropolymer (degree of fluorine substitution of 0%). Preferred is a non-fluoropolymer.

The degree of fluorine substitution of the fluoropolymer is more preferably 90% or less, still more preferably 70% or less, further preferably 50% or less, while it is preferably 10% or more, more preferably 20% or more.

Examples of the fluoropolymer include: fluororesins such as an ethylene (ET)/tetrafluoroethylene (TFE) copolymer (ETFE), an Et/TFE/hexafluoropropylene (HFP) copolymer (EFEP), polychlorotrifluoroethylene (PCTFE), a chlorotrifluoroethylene (CTFE)/TFE copolymer, a CTFE/TFE/perfluoro (alkyl vinyl ether) (PAVE) copolymer, an Et/CTFE copolymer, polyvinyl fluoride (PVF), polyvinylidene fluoride (PVdF), a vinylidene fluoride (VdF)/TFE copolymer, a VdF/HFP copolymer, a VdF/TFE/HFP copolymer, a VdF/HFP/(meth)acrylic acid copolymer, a VdF/CTFE copolymer, a VdF/pentafluoropropylene copolymer, and a VdF/PAVE/TFE copolymer; and fluoroelastomers such as a vinylidene fluoride (VdF)-based fluoroelastomer, a tetrafluoriethylene (TFE)/propylene (Pr)-based fluoroelastomer, a TFE/Pr/VdF-based fluoroelastomer, an ethylene (Et)/hexafluoropropylene (HFP)-based fluoroelastomer, an Et/HFP/VdF-based fluoroelastomer, an Et/HFP/TFE-based fluoroelastomer, a fluorosilicone-based fluoroelastomer, and a fluorophosphazene-based fluoroelastomer.

Examples of the non-fluoropolymers include: non-fluororesins such as polyethylene (PE) including ultra-high-molecular-weight polyethylene, polypropylene (PE), polybutylene terephthalate (PBT), and polyphenylene sulfide (PPS); non-fluoroelastomers such as nitrile rubber, hydrogenated nitrile rubber, styrene-butadiene rubber (SBR), chloroprene rubber (CR), butadiene rubber (BR), natural rubber (NR), isoprene rubber (IR), ethylene-α-olefin rubber, ethylene-α-olefin-non-conjugated diene rubber, chlorinated polyolefin rubber, chlorosulfonated polyolefin rubber, acrylic rubber, ethylene-based acrylic rubber, epichlorohydrin rubber, silicone rubber, butyl rubber (IIR), ethylene-vinyl ester rubber, and ethylene-methacrylate rubber; thermosetting resins such as phenolic resin, epoxy resin, melamine resin, urea resin, unsaturated polyester resin, alkyd resin, silicone resin, polyurethane, and thermosetting polyimide; and crosslinked resins such as crosslinked acrylic resin and crosslinked polyethylene.

In particular, preferred are non-fluororesins, more preferred is at least one selected from the group consisting of PE, PP, PBT and PPS, and still more preferred is at least one selected from the group consisting of PE, PP, and PBT.

For its excellent compression resistance, at least one selected from the group consisting of PP and PBT is particularly preferred.

In order to achieve much better water vapor barrier properties, preferred are PE and PP, and more preferred is PE.

In order to achieve much better water vapor barrier properties, the PE is preferably ultra-high-molecular-weight PE. The ultra-high-molecular-weight PE preferably has a weight average molecular weight of 1.0×10⁶ or more, more preferably 2.0×10⁶ or more, while preferably 7.0×10⁷ or less, more preferably 7.0×10⁶ or less.

The weight average molecular weight of the ultra-high-molecular-weight PE can be determined by gel permeation chromatography (GPC) in polystyrene equivalent.

Examples of commercially available ultra-high-molecular-weight PE include TIVAR UHMW-PE available from Mitsubishi Chemical Advanced Materials AG and HI-ZEX MILLION available from Mitsui Chemicals, Inc.

The gasket (2) of the disclosure may contain a component other than the polymer but preferably consists essentially of the polymer. This allows remarkable exertion of the effect attributable to the polymer. The phrase “consists essentially of the polymer” means that the amount of the polymer is 95.0% by mass or more based on the gasket.

The amount of the polymer is preferably 98.0% by mass or more, more preferably 99.0% by mass or more, still more preferably 99.5% by mass or more, particularly preferably 99.9% by mass or more, most preferably 99.95% by mass or more based on the gasket. The gasket (2) of the disclosure also preferably consists of the polymer.

The gasket of the disclosure can be produced by molding a raw-material polymer into a desired shape. The raw-material polymer may be in any form such as powder, pellets, or a dispersion, and is preferably in the form of powder or pellets.

It is preferable to select a raw-material polymer having a compression ratio at break greater than the desired compression ratio.

The raw-material polymer may be molded by any method and any known molding method can be employed, such as cutting processing, injection molding, extrusion molding, or compression molding. Alternatively, a rubber composition containing a rubber and a crosslinking agent (and optionally a crosslinking aid) may be crosslinked and molded by a known method.

The gasket of the disclosure is a member used in an electrochemical device to prevent the leakage of liquid or gas or the intrusion of liquid or gas from the outside.

The gasket of the disclosure may have any shape such as a ring shape. The gasket of the disclosure may have a shape such as a circle, an ellipse, or a rectangle with rounded corners in a plan view, and may have a through-hole in the center.

A usage form of the gasket according to an embodiment of the disclosure is described with reference to the drawing.

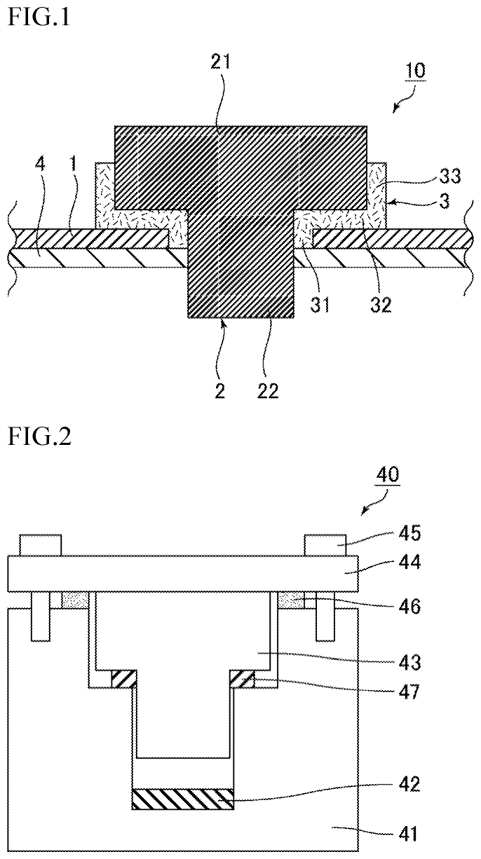

An electrochemical device 10 (such as a sealed type rectangular secondary battery) in FIG. 1 includes an outer can (not illustrated) and a lid 1. An electric element (not illustrated) such as a power generator is housed inside the outer can, and the opening of the outer can is hermetically sealed with the lid 1.

The lid 1 is provided with an external terminal 2 (positive electrode terminal or negative electrode terminal). Externally generated power is supplied to the electric element via the external terminal 2 for storage, and the stored power is supplied to an external load via the external terminal 2.

A gasket 3 is provided between the external terminal 2 and the lid 1 for sealing and insulation. The gasket 3 corresponds to the gasket of the disclosure.

An insulating plate 4 is provided on the lid 1 to electrically insulate the external terminal 2 from the lid 1.

The external terminal 2 has a terminal head 21 having a rectangular parallelepiped block shape and a columnar shaft 22. The shaft 22 protrudes from the lower surface (on the inner side of the electrochemical device) of the terminal head 21.

As illustrated in FIG. 1, the gasket 3 has a cylinder portion 31, a flange portion 32 that extends radially outward from one end of the opening of the cylinder portion 31, and a side wall portion 33 that rises from the periphery of the flange portion 32.

The cylinder portion 31 is fitted onto the shaft 22 of the external terminal 2, and the inner circumferential surface of the cylinder portion 31 is in contact with the outer circumferential surface of the shaft 22. The cylinder portion 31 is inserted into the through hole of the lid 1, and the outer circumferential surface of the cylinder portion 31 is in contact with the inner circumferential surface of the through hole of the lid 1.

The flange portion 32 is sandwiched between the lid 1 and the external terminal 2, with one contact surface of the flange portion 32 being in contact with the bottom surface of the external terminal 2 and the other contact surface of the flange portion 32 being in contact with the top surface of the lid 1.

The gasket 3 comes into contact with the external terminal 2 and the lid 1 with the cylinder portion 31 and the flange portion 32 of the gasket 3 in a compressed state, thereby ensuring the hermeticity of the electrochemical device.

The gasket of the disclosure is used in electrochemical devices such as batteries and capacitors.

Examples of batteries include secondary batteries such as lithium ion batteries.

The binder may be used in any capacitor. An electrochemical capacitor is preferred. Examples of electrochemical capacitors include electric double layer capacitors, hybrid capacitors, and redox capacitors. Examples of hybrid capacitors include sodium ion capacitors, lithium ion capacitors, and magnesium ion capacitors. Among these, electric double layer capacitors are particularly preferred.

The gasket of the disclosure is suitably used as a gasket for a battery, and is particularly suitably used as a gasket for a secondary battery such as a lithium-ion battery.

The secondary battery may be a secondary battery including an electrolyte solution or may be a solid-state secondary battery.

The solid-state secondary battery herein is a secondary battery containing a solid electrolyte. It may be a semi-solid-state secondary battery containing, as an electrolyte, a solid electrolyte and a liquid component, or an all-solid-state secondary battery containing a solid electrolyte alone as an electrolyte.

The gasket of the disclosure is preferably in contact with an electrolyte, that is, the gasket of the disclosure preferably has a surface that contacts the electrolyte. The gasket of the disclosure having excellent water vapor barrier properties can reduce or prevent intrusion of water into the electrolyte when used in contact with the electrolyte.

The electrolyte here encompasses not only the electrolyte itself provided in the electrochemical device, but also substances derived from the electrolyte, and may be liquid, solid, or gas. The gas encompasses, for example, gas resulting from the volatilization of the electrolyte or gas generated by the decomposition of the electrolyte solution during charging and discharging.

The electrochemical device of the disclosure preferably includes a non-aqueous electrolyte solution. The gasket of the disclosure is preferably used in contact with a non-aqueous electrolyte solution, that is, the gasket of the disclosure preferably has a surface that contacts the non-aqueous electrolyte solution.

The non-aqueous electrolyte solution used may be a solution obtained by dissolving a known electrolyte salt in a known organic solvent for dissolving an electrolyte salt.

Any organic solvents for dissolving electrolyte salts may be used. One or more of known hydrocarbon solvents such as propylene carbonate, ethylene carbonate, butylene carbonate, γ-butyrolactone, 1,2-dimethoxyethane, 1,2-diethoxyethane, dimethyl carbonate, diethyl carbonate, and ethyl methyl carbonate; and fluorine solvents such as fluoroethylene carbonate, fluoroether, and fluorinated carbonate can be used.

Examples of electrolyte salts include LiClO₄, LiAsF₆, LiBF₄, LiPF₆, LiN(SO₂CF₃)₂, and LiN(SO₂C₂F₅)₂, LiCl, LiBr, CH₃SO₃Li, CF₃SO₃Li, and cesium carbonate. In order to achieve favorable cycle characteristics, preferred is LiPF₆, LiBF₄, LiN(SO₂CF₃)₂, LiN(SO₂C₂F₅)₂, or a combination of any of these.

The concentration of the electrolyte salt is preferably 0.8 mol/L or higher, more preferably 1.0 mol/L or higher. The upper limit is usually 1.5 mol/L, though it depends on the organic solvent for dissolving an electrolyte salt used.

The solid electrolyte used in a solid-state secondary battery may be a sulfide-based solid electrolyte or an oxide-based solid electrolyte. In particular, a sulfide-based solid electrolyte has an advantage of being flexible.

The sulfide-based solid electrolyte is not limited. The sulfide-based solid electrolyte used may be any one selected from Li₂S—P₂S₅, Li₂S—P₂S₃, Li₂S—P₂S₃—P₂S₅, Li₂S—SiS₂, LiI—Li₂S—SiS₂, LiI—Li₂S—P₂S₅, LiI—Li₂S—P₂O₅, LiI—Li₃PO₄—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄ (X=0.6 to 0.8), Li_{4+y}Ge_{1-y}Ga_{y}S₄ (y=0.2 to 0.3), LiPSCl, LiCl, Li_{7-x-2y}PS_{6-x-y}Clₓ (0.8≤x≤1.7, 0<y≤−0.25x+0.5), and Li₁₀SnP₂S₁₂, or a mixture of two or more thereof.

The sulfide-based solid electrolyte preferably contains lithium. Sulfide-based solid electrolytes containing lithium are used in solid-state batteries in which lithium ions are used as carriers, and are particularly preferred in that they provide electrochemical devices having high energy density.

The oxide-based solid electrolyte is preferably a compound that contains an oxygen atom (O), has conductivity of metal ions belonging to Group 1 or Group 2 of the periodic table, and has electronic insulating properties.

Specific examples of the compound include LiₓₐLa_{ya}TiO₃ (xa=0.3 to 0.7, ya=0.3 to 0.7) (LLT), Li_{xb}La_{yb}Zr_{zb}M^{bb}_{mb}O_{nb} (wherein M^{bb} includes at least one element selected from Al, Mg, Ca, Sr, V, Nb, Ta, Ti, Ge, In, and Sn; xb satisfies 5≤xb≤10; yb satisfies 1≤yb≤4; zb satisfies 1≤zb≤4; mb satisfies 0≤mb≤2; and nb satisfies 5≤nb≤20), Li_{xc}B_{yc}M^{cc}_{zc}O_{nc} (wherein M^{cc} includes at least one element selected from C, S, Al, Si, Ga, Ge, In, and Sn; xc satisfies 0≤xc≤5; yc satisfies 0≤yc≤1; zc satisfies 0≤zc≤1; and nc satisfies 0≤nc≤6), Li_{xd}(Al, Ga)_{yd}(Ti, Ge)_{zd}Si_{ad}P_{md}O_{nd} (1≤xd≤3, 0≤yd≤2, 0≤zd≤2, 0≤ad≤2, 1≤md≤7, and 3≤nd≤15), Li₍₃₋₂ₓₑ₎M^{cc}ₓₑD^{ee}O (wherein xe is a number of 0 or greater and 0.1 or smaller, M^{cc} is a divalent metal atom, D^{cc} is a halogen atom or a combination of two or more halogen atoms), Li_{xf}Si_{yf}O_{zf} (1≤xf≤5, 0<yf≤3, and 1≤zf≤10), Li_{xg}S_{yg}O_{zg} (1≤xg≤3,0<yg≤2, and 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w<1), Li_{3.5}Zn_{0.25}GeO₄ having a lithium super ionic conductor (LISICON) crystal structure, La_{0.51}Li_{0.34}TiO_{2.94} having a perovskite crystal structure, La_{0.55}Li_{0.35}TiO₃, LiTi₂P₃O₁₂ having a natrium super ionic conductor (NASICON) crystal structure, Li_{1+xh+yh}(Al,Ga)ₓₕ(Ti,Ge)₂₋ₓₕSi_{yh}P_{3-yh}O₁₂ (0≤xh≤1 and 0≤yh≤1), and Li₇La₃Zr₂O₁₂ (LLZ) having a garnet crystal structure. Ceramic materials in which element substitution is performed for LLZ are also known. Examples thereof include Li_{6.24}La₃Zr₂Al_{0.24}O_{11.98} and Li_{6.25}Al_{0.25}La₃Zr₂O₁₂ in which partial element substitution using Al is performed for LLZ, Li_{6.6}La₃Zr_{1.6}Ta_{0.4}O₁₂ in which partial element substitution using Ta is performed for LLZ, and Li_{6.75}La₃Zr_{1.75}Nb_{0.25}O₁₂ in which partial element substitution using Nb is performed for LLZ. Other examples include LLZ-based ceramic materials in which element substitution using at least one of magnesium (Mg) and A (A includes at least one element selected from the group consisting of calcium (Ca), strontium (Sr), and barium (Ba)) is performed for LLZ. Phosphorus compounds containing Li, P and O are also desirable. Examples include lithium phosphate (Li₃PO₄), LiPON in which one or more oxygen atoms in lithium phosphate are replaced with nitrogen, and LiPOD¹ (wherein D¹ includes at least one selected from Ti, V, Cr, Mn, Fe, Co, Ni, Cu, Zr, Nb, Mo, Ru, Ag, Ta, W, Pt, Au, and the like). LiA¹ON (wherein A¹ includes at least one selected from Si, B, Ge, Al, C, Ga, and the like) can also be preferably used. Specific examples include Li₂O—Al₂O₃—SiO₂—P₂O₅—TiO₂—GeO₂ and Li₂O—Al₂O₃—SiO₂—P₂O₅—TiO₂.

The oxide-based solid electrolyte preferably contains lithium. Oxide-based solid electrolytes containing lithium are used in solid-state batteries in which lithium ions are used as carriers, and are particularly preferred in that they provide electrochemical devices having high energy density.

The oxide-based solid electrolyte is preferably an oxide having a crystal structure. Oxides having a crystal structure are particularly preferred in terms of good Li ion conductivity. The oxide having a crystal structure may be of perovskite type (e.g., La_{0.51}Li_{0.34}TiO_{2.94}), NASICON type (e.g., Li_{1.3}Al_{0.3}Ti_{1.7}(PO₄)₃), or garnet type (e.g., Li₇La₃Zr₂O₁₂ (LLZ)). Preferred among these is the garnet type.

An electrochemical device including the gasket of the disclosure is also one aspect of the disclosure.

It should be appreciated that a variety of modifications and changes in the structure and other details may be made to the aforementioned embodiments without departing from the spirit and scope of the claims.

The disclosure (1) relates to a gasket for an electrochemical device containing polybutylene terephthalate, the gasket having a compression ratio upon installation of 5% or more.

The disclosure (2) relates to the gasket according to the disclosure (1), wherein the compression ratio is less than a compression ratio at break.

The disclosure (3) relates to the gasket according to the disclosure (1) or (2), wherein the gasket has a water vapor transmission coefficient of less than 0.010 g/1000 hr. The disclosure (4) relates to the gasket according to any one of the disclosures (1) to (3), wherein the gasket is in contact with an electrolyte.

The disclosure (5) relates to an electrochemical device including the gasket according to any one of the disclosures (1) to (4).

The disclosure (6) relates to a gasket for an electrochemical device, containing a polymer, the gasket having a compression ratio upon installation of 20% or more and 75% or less.

The disclosure (7) relates to the gasket according to the disclosure (6), wherein the compression ratio is less than a compression ratio at break.

The disclosure (8) relates to the gasket according to the disclosure (6) or (7), wherein the gasket has a water vapor transmission coefficient of less than 0.010 g/1000 hr.

The disclosure (9) relates to the gasket according to any one of the disclosures (6) to (8), wherein the polymer has a degree of fluorine substitution of 95% or less.

The disclosure (10) relates to the gasket according to any one of the disclosures (6) to (9), wherein the polymer includes at least one polymer selected from the group consisting of polyethylene, polypropylene, polybutylene terephthalate, and polyphenylene sulfide.

The disclosure (11) relates to the gasket according to any one of the disclosures (6) to (10), wherein the gasket is in contact with an electrolyte.

The disclosure (12) relates to an electrochemical device including the gasket according to any one of the disclosures (6) to (11).

### EXAMPLES

The disclosure is described in more detail below with reference to examples, but is not limited to these examples.

### Examples 1 to 9

### <Raw Material>

Polypropylene (PP) (trade name: Prime Polypro F227, Prime Polymer Co., Ltd.)

Polybutylene terephthalate (PBT) (trade name: PBT Natural color, unfilled, Kureha Extron Co., Ltd.) Ultra-high-molecular-weight polyethylene (UHMWPE) (trade name: Hi-zex Million, Mitsui Chemicals, inc.)

### <Compression Ratio at Break (Compression Ratio Upon Breakage)>

A compression test was conducted in accordance with JIS K 7181:2011 on three types of materials: PP, PBT, and UHMWPE, using a ring-shaped gasket with a rectangular cross section, an outer diameter of 17.7±0.1 mm, an inner diameter of 14.2±0.1 mm, and a thickness of 1.6±0.05 mm (L₀). The gasket was compressed to the specified compression ratio and then released. The resulting gasket was taken out and observed under a microscope, whereby the compression ratio at break was determined. The specified compression ratios were set in 5% increments, such as 60%, 65%, 70%, 75%, and 80%, and compression was performed using ten gaskets for each ratio. The compression ratio at which creasing begins to occur on the surface or inside of the gasket was defined as the compression ratio at break. The results are shown in Table 1.

### <Test Piece>

The polymer was heated to above its melting point and a sheet was formed. Using the sheet, a ring-shaped gasket with a rectangular cross section, an inner diameter of 14.3 mm, an outer diameter of 17.7 mm, and a height of 1.6 mm was fabricated.

### <Water Vapor Transmission Test>

As shown in FIG. 2, 2 g of water 42 was placed in an aluminum alloy cup 41. A gasket 47 was placed between the cup 41 and a gasket compression jig 43, and a lid 44 was fastened with a bolt 45 to compress the gasket 47. A spacer 46 was installed between the lid 44 and the cup 41, allowing the compression ratio of the gasket 47 to be adjusted to 12.5%, 37.5%, or 62.5%.

The compression ratio was determined using the following formula.

$$( Compression ratio of gasket ( \% ) ) = \{ 1 - ( Distance of gap ( where gasket is placed ) between cup 41 and gasket compression jig 43 ) / ( height of gasket before compression ) \} \times 100$$

The mass of a transmission test jig 40 thus obtained was measured. The transmission test jig 40 was placed in an electric furnace at 80° C. and left for 1000 hours. The transmission test jig 40 was then taken out and left at room temperature for two hours, followed by measurement of the mass. The water vapor transmission coefficient was determined using the following formula. The above operation was repeated three times to determine the average of the water vapor transmission coefficient. The average values are shown in Table 2.

$$Water vapor transmission coefficient ( g / 1000 hr ) = ( Mass of transmission test jig before heating ) - ( Mass of transmission test jig after heating )$$

TABLE 1

| Material | PP | PBT | UHMWPE |
|---|---|---|---|
| Compression ratio | 75 | 65 | 75 |
| at break (%) | | | |

TABLE 2

| | Example 1 | Example 2 | Example 3 | Example 4 | Example 5 | Example 6 | Example 7 | Example 8 | Example 9 |
|---|---|---|---|---|---|---|---|---|---|
| Material | PP | PBT | UHMWPE | PP | PBT | UHMWPE | PP | PBT | UHMWPE |
| Compression ratio (%) | 37.5 | 37.5 | 37.5 | 62.5 | 62.5 | 62.5 | 12.5 | 12.5 | 12.5 |
| Water vapor transmission | 0.005 | 0.007 | 0.003 | 0.001 | 0.002 | 0.001 | 0.019 | 0.013 | 0.016 |
| coefficient (g/1000 hr) | | | | | | | | | |

### REFERENCE SIGNS LIST

10: electrochemical device
1: lid
2: external terminal
21: terminal head
22: shaft
3: gasket
31: cylinder portion
32: flange portion
33: side wall portion
4: insulating plate
40: transmission test jig
41: cup
42: water
43: gasket compression jig
44: lid
45: bolt
46: spacer
47: gasket

1. A gasket for an electrochemical device comprising polybutylene terephthalate,
the gasket having a compression ratio upon installation of 5% or more.

2. The gasket according to claim 1,
wherein the compression ratio is less than a compression ratio at break.

3. The gasket according to claim 1,
wherein the gasket has a water vapor transmission coefficient of less than 0.010 g/1000 hr.

4. The gasket according to claim 1,
wherein the gasket is in contact with an electrolyte.

5. An electrochemical device comprising the gasket according to claim 1.
